(19) United States
(12) Patent Application Publication
(10) Pub. No.: US 2009/0084012 A1
(43) Pub. Date: Apr. 2, 2009

(54) LOW PROFILE NAME CARD CARRIER

(75) Inventor: Tsung-Min Kung, Kaohsiung City (TW)

Correspondence Address: TAIWAN INDUSTRIAL FASTENER CORPORATION, P. O. BOX 108-00403, TAIPEI, TW

(73) Assignee: NIFCO TAIWAN CORPORATION, Taipei (TW)

(21) Appl. No.: 11/865,710

(22) Filed: Oct. 1, 2007

(51) Int. Cl. G09F 3/18

(52) U.S. Cl. 40/642.02

(57) ABSTRACT

A low profile name card carrier includes a housing, a sliding board, which has two guide rods respectively coupled to respective tracks in the housing to guide movement of the sliding board in and out of the housing, a label adhered to the sliding board, and a torsional spring, which has a compressible spring body suspending inside the housing and two end portions respectively fastened to a recessed hole at an inner end of the sliding board and a locating block inside the housing.

### BACKGROUND OF THE INVENTION

1. Field of the Invention

The present invention relates to a name card carrier for holding name cards and more particularly, to a low profile name card carrier, which uses a spring member to support the sliding board between the received position and the extended position, and has a label adhered to the sliding board for the marking of the user's personal data.

2. Description of the Related Art

Many people go abroad frequently either for sightseeing or business. When traveling, one will use a travel bag or luggage to carry clothes and many other personal items. However, airline companies do not allow passengers to carry big travel bags or luggage to their seats, and big travel bags or luggage must be separately delivered by cargo. When arrived the destination airport, passengers must take back their travel bags or luggage. For quick identification, travel bags or luggage must be respectively fastened with a tag carrying the owner's personal data, such as name, address, telephone number, cell phone number, e-mail, etc. A tag for this purpose is simply a strip of hard paper. However, when a tag is wetted by water accidentally, the written data may become unclear and not readable. When the written data of the tag of a travel bag or luggage is not readable, the identification of the travel bag or luggage becomes difficult. Further, in case of miswriting, the written data must be corrected. However, it may be difficult to recognize the corrected data.

In order to eliminate the aforesaid problems, a name card carrier (or label carrier) is developed. FIGS. 7 and 8 show a name card carrier (label carrier) according to the prior art. As illustrated, the name card carrier is comprised of a housing A, a sliding board B, a spring member C and a label D. The housing A comprises an accommodation chamber A1, two longitudinal sliding grooves A2 disposed at two opposite lateral sides of the accommodation chamber A1, an opening A11 at one end of the accommodation chamber A1, and a stop rod A12 on the middle of the opening A11. The sliding board B is inserted into the accommodation chamber A1 of the housing A, having two rails B2 disposed at the two opposite sides of the rear end and respectively coupled to the longitudinal sliding grooves A2 of the housing A, and a longitudinal locating groove B1 on the middle of the bottom wall The spring member C is a compression spring positioned in the longitudinal locating groove B1 and stopped between one end of the longitudinal locating groove B1 and the stop rod A12 of the housing A. The label D is adhered to the top surface of the sliding board B for writing the user's personal data. The spring member C imparts a pressure to the sliding board B, holding the sliding board B inside the housing A. According to this design, the spring member C is a compression spring having a certain length and outer diameter. Further, the sliding board B has a certain thickness so that the spring member C can be accommodated in the longitudinal locating groove B1. Because of the aforesaid limitations, the name card carrier (label carrier) does not fit the requirement for low profile.

### SUMMARY OF THE INVENTION

The present invention has been accomplished under the circumstances in view. It is the main object of the present invention to provide a name card carrier, which has a low profile. To achieve this and other objects of the present invention, the name card carrier comprises a housing, a sliding board, which has two guide rods respectively coupled to respective tracks in the housing to guide movement of the sliding board in and out of the housing, a label adhered to the sliding board, and a spring member coupled between the housing and the sliding board. The spring member comprises a compressible spring body suspending inside the housing and two end portions respectively extending from two distal ends of the compressible spring body and respectively fastened to a recessed hole at an inner end of the sliding board and a locating block inside the housing. The two end portions define with the compressible spring body a contained angle. The contained angle is an obtuse angle when the sliding board is in the received or extended position. The contained angle is gradually changed from the obtuse angle to an acute angle during movement of the sliding board between the received position and the extended position.

### BRIEF DESCRIPTION OF THE DRAWINGS

FIG. 1 is an oblique elevational view of a name card carrier in accordance with the present invention.

FIG. 2 is an exploded view of the name card carrier in accordance with the present invention.

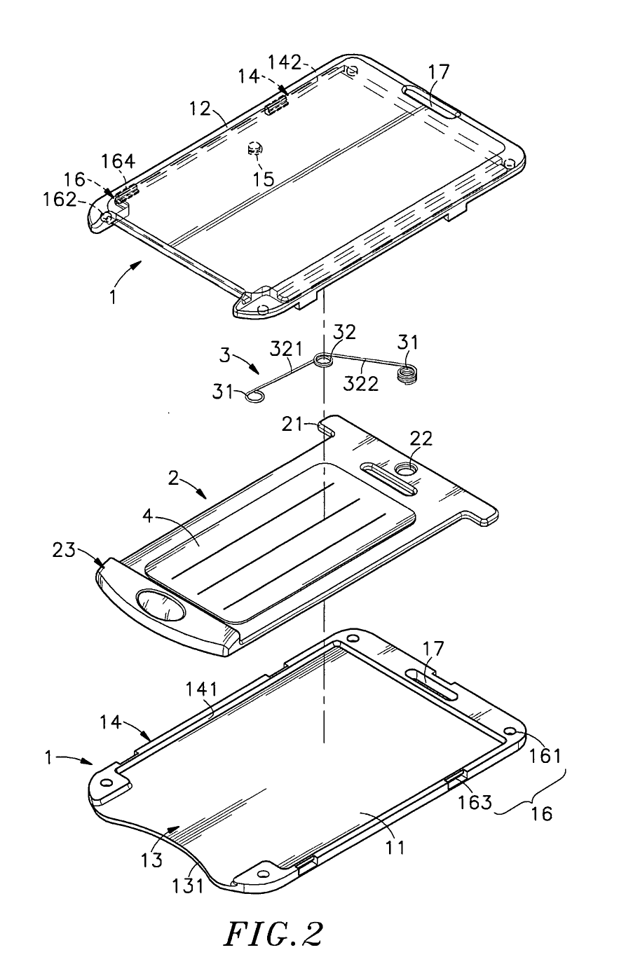

FIG. 3 is a top plain view of the present invention, showing the sliding board in the received position.

FIG. 4 is another top plain view of the present invention, showing the sliding board moved toward the outside of the housing.

FIG. 5 is still another top plain view of the present invention, showing the sliding board moved toward the outside of the housing.

FIG. 6 is still another top plain view of the present invention, showing the sliding board in the extended position.

FIG. 7 is an exploded view of a name card carrier according to the prior art.

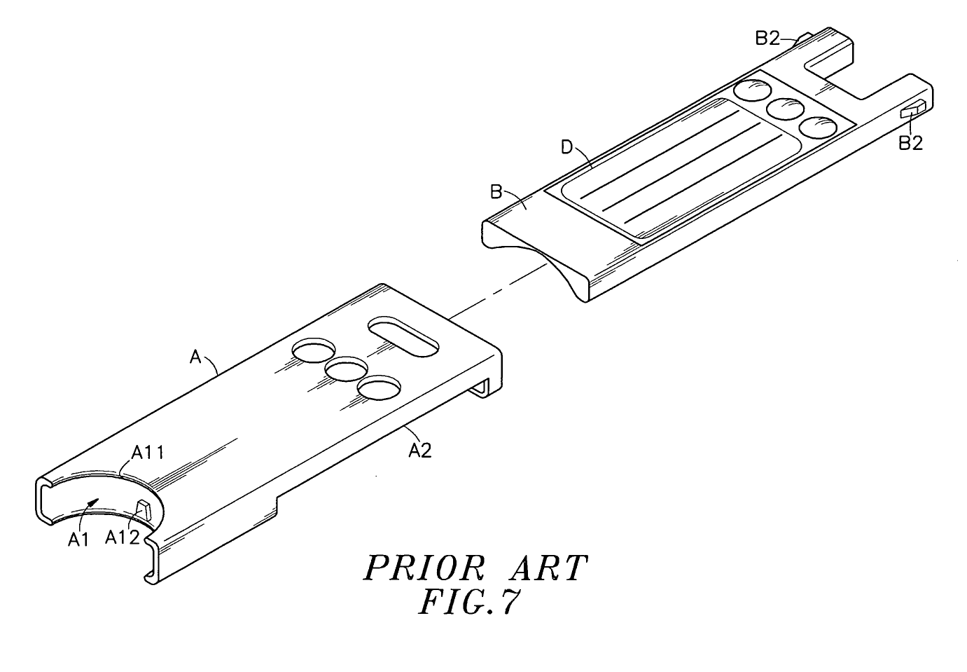

FIG. 8 is another exploded view of the prior art name card carrier when viewed from another angle.

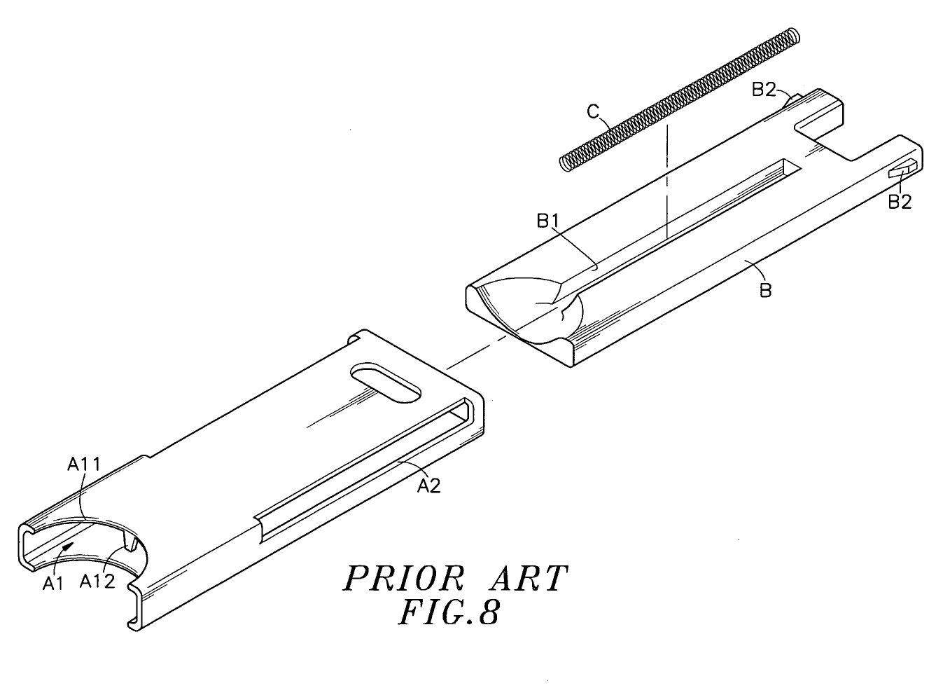

### DETAILED DESCRIPTION OF THE PREFERRED EMBODIMENT

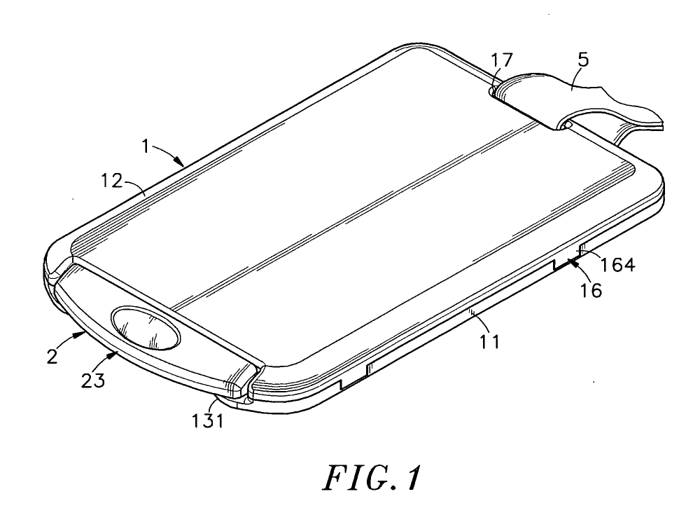

Referring to FIGS. 1˜3, a name card carrier in accordance with the present invention is shown comprised of a housing 1, a sliding board 2 and a spring member 3.

The housing 1 is comprised of a flat bottom cover shell 11 and a flat top cover shell 12. The flat bottom cover shell 11 and the flat top cover shell 12 may be formed in integrity. Alternatively, the flat bottom cover shell 11 and the flat top cover shell 12 can be separately made and then bonded together. The housing 1 comprises a flat accommodation chamber 13 defined in between the flat bottom cover shell 11 and the flat top cover shell 12, an opening 131 curved inwards at one side of the flat accommodation chamber 13, two tracks 14 arranged in parallel at two opposite lateral sides inside the flat accommodation chambers 13, each track 14 comprising a sliding groove 141 disposed at one lateral side of the flat bottom cover shell 11 and a sliding rail 142 disposed at the corresponding lateral side of the flat top cover shell 12, a locating block 15 downwardly protruded from the bottom wall of the flat top cover shell 12 and suspending in the flat accommodation chamber 13, a mounting structure 16, which comprises a plurality of mounting holes 161 and mounting notches 163 respectively formed in the flat bottom cover shell 11 and a plurality of mounting rods 162 and mounting hooks 164 respectively disposed at the flat top cover shell 12 and respectively fastened to the mounting holes 161 and the mounting notches 163 at the flat bottom cover shell 11, and a hanging hole 17 cut through the flat bottom cover shell 11 and the flat top cover shell 12 at one side opposite to the opening 131.

The sliding board 2 is a flat board inserted into the flat accommodation chamber 13 of the housing 1, having two guide rods 21 respectively perpendicularly extended from its one end, namely, the inner end, a recessed hole 22 on its inner end between the guide rods 21, and a grip 23 disposed at its opposite end, namely, the outer end.

The spring member 3 can be a coiled spring or spring plate that can quickly be positioned in the other corresponding position after a displacement of the sliding board 2. According to the present preferred embodiment, the spring member 3 is a torsional spring comprising a coiled spring body 32 on the middle, two end portions 31, and two spring arms, namely, the first spring arm 321 and the second spring arm 322 respectively extending from the two opposite ends of the coiled spring body 32 and connected to the two end portions 31.

During installation, the guide rods 21 of the sliding board 2 are respectively coupled to the sliding grooves 141 of the tracks 14 to guide movement of the sliding board 2 in and out of the flat accommodation chamber 13 of the housing 1 along the sliding rails 142 of the tracks 14, and the spring member 3 is coupled between the housing 1 and the sliding board 2 with its two end portions 31 respectively fastened to the recessed holes 22 of the sliding board 2 and fastened to the locating block 15 of the flat top cover shell 12. After installation, the bottom edge of the locating block 15 is above the elevation of the bottom edge of the sliding rails 142. Therefore, the locating block 15 does not touch the sliding board 2, and moving the sliding board 2 in and out of the accommodation chamber 13 of the housing 1 does not cause the locating block 15 to damage the surface of the sliding board 2 and will not case noise.

Further, the mounting holes 161 and the mounting notches 163 at the flat bottom cover shell 11 are respectively fastened to the mounting rods 162 and mounting hooks 164 at the flat top cover shell 12 after the two end portions 31 of the spring member 3 have been respectively fastened to the recessed holes 22 of the sliding board 2 and fastened to the locating block 15 of the flat top cover shell 12. When the name card carrier is assembled, the grip 23 of the sliding board 2 is suspending outside the opening 131 of the housing 1. Further, a cord, ribbon, strap or belt member 5 can be fastened to the hanging hole 17 to secure the name card carrier to a luggage, travel bag, backpack, purse, portfolio or dress to be carried by the user or put on the user's body.

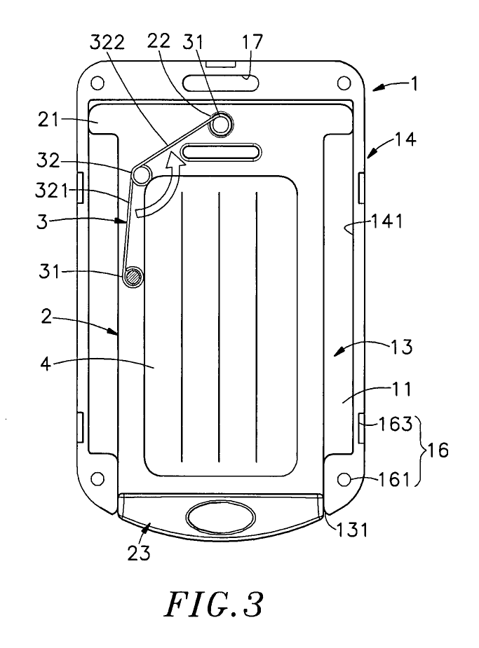

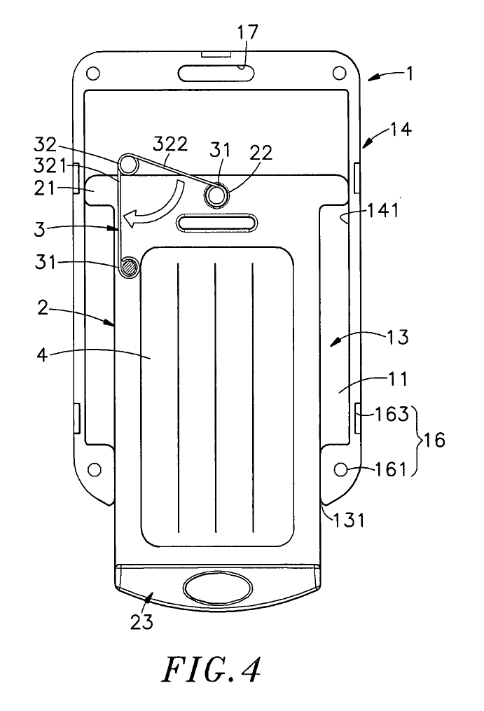

Referring to FIGS. 4˜6 and FIG. 3 again, by means of the grip 23, the user can move the sliding board 2 in and out of the housing 1 conveniently between the received position where the guide rods 21 are respectively stopped at the outer ends of the sliding grooves 141 inside the housing 1 and the extended position where the grip 23 is closely attached to the front end of the housing 1 outside the opening 131.

When the sliding board 2 is received in the received position, the guide rods 21 of the sliding board 2 are stopped at the inner ends of the sliding grooves 141 inside the housing 1, and the two spring arms 321 and 322 of the spring member 3 define an obtuse angle and impart a pressure to the sliding board 2 against the inner ends of the sliding grooves 141 of the housing 1, and therefore the sliding board 2 is kept stably in the received position (see FIG. 3).

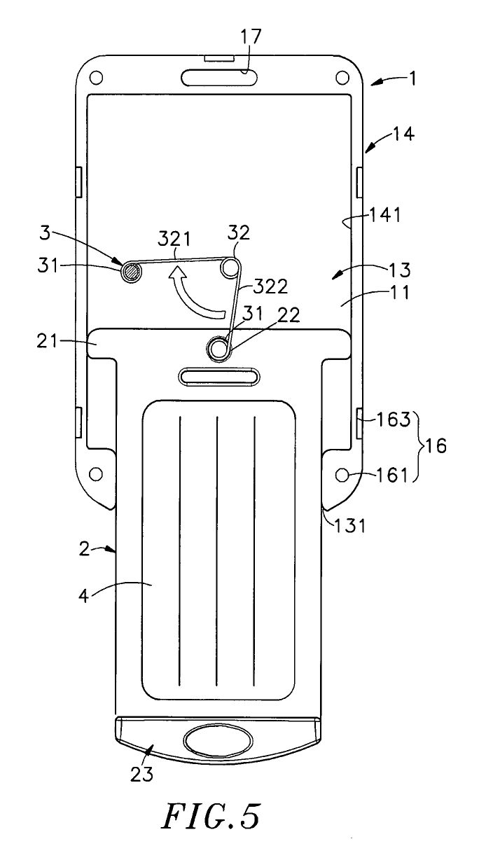

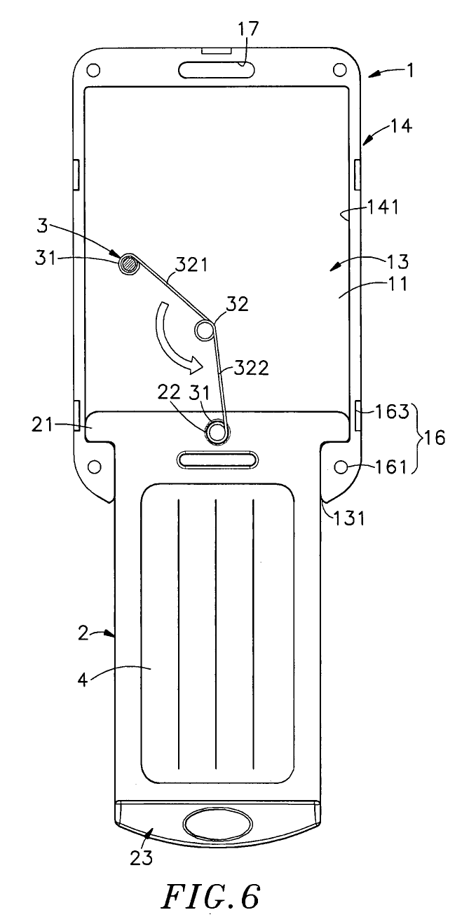

When pulling the sliding board 2 along the sliding grooves 141 and the sliding rails 142 toward the outside of the housing 1, the second spring arm 322 is turned toward the first spring arm 321, and at the same time the contained angle defined between the two spring arms 321 and 322 is gradually reducing from the obtuse angle to an acute angle and the coiled spring body 32 is compressed (see FIGS. 4 and 5). When continuously pulling the sliding board 2 outwards, the spring member 3 is forced to make a sector displacement, allowing the sliding board 2 to be moved to the extended position. When the sliding board 2 is on the midway as it is pulled outwards to the extended position, the amount of compression of the coiled spring body 32 reaches the highest point. When the sliding board 2 is moved over the midway, the contained angle defined between the two spring arms 321 and 322 is gradually increasing from the acute angle to an obtuse angle and the coiled spring body 32 is released to force the sliding board 2 toward the outside of the housing 1, as shown in FIG. 6. Therefore, the spring force of the spring member 3 positively supports the sliding board 2 in one of the received position and the extended position.

Further, as stated above, the housing 1 is formed of the flat bottom cover plate 11 and the flat top cover plate 12, defining a flat accommodation chamber 13 and two tracks 14 at two sides of the flat accommodation chambers 13. The guide rods 21 of the sliding board 2 are respectively coupled to the tracks 14 to guide movement of the sliding board 2 stably in and out of the housing 1 between the received position and the extended position. Further, the sliding board 2 is adhered with a label 4, which has marked thereon the user's personal data such as name, address, telephone number, etc. The label 4 can be bonded to the surface of the sliding board 2 with an adhesive, adhesive tape or bonding resin. Further, the housing 1 can be made out of a transparent or translucent material. Alternatively, the housing 1 can be made having a view window through which the data marked on the label 4 can be seen from the outside. Further, because the sliding board 2 is normally received inside the housing 1, the label 4 is well protected inside the housing 1. Further, after removal of the label 4 from the sliding board 2, a new label 4 can be bonded to the sliding board 2 for the marking of new data.

Further, the sliding board 2 is closely supported the top surface of the flat bottom cover plate 11 with the guide rods 21 respectively coupled to the tracks 14 and two opposite lateral sides thereof respectively disposed in contact with the two opposite lateral side edges of the opening 131. Therefore, the sliding board 2 can be moved in and out of the housing 1 smoothly and stably without noises. Further, the spring member 3 is forced to make a sector displacement during movement of the sliding board 2 relative to the housing 1 between the received position and the extended position. This design fits low profile requirement, and therefore the name card carrier has a small thickness.

According to the aforesaid preferred embodiment, the mounting holes 161 and the mounting notches 163 are provided at the flat bottom cover shell 11, and the mounting rods 162 and the mounting hooks 164 are provided at the flat top cover shell 12 for fastening to the mounting holes 161 and the mounting notches 163 at the flat bottom cover shell 11. Alternatively, the mounting holes 161 and the mounting notches 163 can be provided at the flat top cover shell 12, and the mounting rods 162 and the mounting hooks 164 can be provided at the flat bottom cover shell 11 for fastening to the mounting holes 161 and the mounting notches 163 at the flat top cover shell 12. Further, other mounting structures or fastening means may be used to substitute for the aforesaid mounting holes 161, mounting rods 162, mounting notches 163 and mounting hooks 164.

As stated above, the invention provides a name card carrier that has the following advantages and features:

1. By means of a sector displacement of the spring member 3, the sliding board 2 can easily be moved in and out of the housing 1 and then quickly positioned in the received or extended position.

2. The tracks 14 of the housing 1 guide movement of the sliding board 2 stably in and out of the housing 1, and prohibit the sliding board 2 from falling out of the housing 1.

3. The bottom edge of the locating block 15 is disposed above the elevation of the sliding rails 142, and therefore, the locating block 15 is spaced above the sliding board 2 at a distance. During sliding movement of the sliding board 2, the locating block 15 does not scratch the surface of the sliding board 2 and will not cause noises.

4. The two end portions 31 of the spring member 3 are respectively fastened to the locating rod 15 of the flat top cover plate 12 and the recessed hole 22 of the sliding board 2 so that the spring member 3 is forced to make a sector displacement when the sliding board 2 is moved between the received position and the extended position, and the spring member 3 gives a pressure to the sliding board 2 toward the received or extended position, and therefore the sliding board 2 is prohibited from sliding accidentally.

5. The spring member 3 is designed to make a sector displacement when the sliding board 2 is moved between the received position and the extended position, and therefore the length of the spring member 3 is minimized and the use of the spring member 3 fits low profile requirement.

6. Through the hanging hole 17 of the housing 1, the name card carrier can be fastened to a luggage, travel bag, backpack, purse, portfolio or dress to be carried by the user or put on the user's body.

7. The sliding board 2 has a label 4 adhered thereto for marking the user's personal data. Normally, the sliding board 2 is received inside the housing 1, and therefore the label 4 is well protected inside the housing 1.

8. After removal of the label 4 from the sliding board 2, a new label 4 can be bonded to the sliding board 2 for the marking of new data.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A name card carrier comprising:
a housing, said housing comprising an accommodation chamber, an opening at a front side thereof in communication between said accommodation chamber and the outside of said housing, two tracks arranged in parallel at two opposite lateral sides inside said accommodation chamber, and a locating block suspending in said accommodation chamber at a top side;
a sliding board inserted through said opening of said housing into said accommodation chamber, said sliding board comprising an outer end exposed to the outside of said housing, an inner end opposite to said outer end, two guide rods respectively extending from two opposite lateral sides of said inner end and respectively coupled to said tracks to guide movement of said sliding board in and out of said housing between a received position and an extended position, and a recessed hole on the middle of said inner end; and
a spring member, said spring member comprising a compressible spring body suspending in said accommodation chamber inside said housing and two end portions respectively extending from two distal ends of said compressible spring body and respectively fastened to said recessed hole of said sliding board and said locating block of said housing, said two end portions defining with said compressible spring body a contained angle, said contained angle being an obtuse angle when said sliding board is in one of said received position and said extended position, said contained angle being gradually changed from said obtuse angle to an acute angle during movement of said sliding board between said received position and said extended position.

2. The name card carrier as claimed in claim 1, wherein said housing comprises a hanging hole at a rear side thereof opposite to said opening for the mounting of a belt member.

3. The name card carrier as claimed in claim 1, wherein said housing is comprised of a bottom cover plate and a top cover plate; said tracks of said housing each comprise a sliding groove and a sliding rail respectively formed on said bottom cover plate and said top cover plate and arranged in parallel at different elevations.

4. The name card carrier as claimed in claim 3, wherein said housing further comprises a mounting structure, said mounting structure comprising a plurality of mounting holes and mounting notches respectively formed in said bottom cover shell and a plurality of mounting rods and mounting hooks respectively disposed at said top cover shell and respectively fastened to said mounting holes and said mounting notches.

5. The name card carrier as claimed in claim 3, wherein said housing further comprises a mounting structure, said mounting structure comprising a plurality of mounting holes and mounting notches respectively formed in said top cover shell and a plurality of mounting rods and mounting hooks respectively disposed at said bottom cover shell and respectively fastened to said mounting holes and said mounting notches.

6. The name card carrier as claimed in claim 1, wherein said sliding board comprises a grip extended from said outer end thereof and exposed to the outside of said housing.

7. The name card carrier as claimed in claim 1, wherein said sliding board has a label bonded thereto.

8. The name card carrier as claimed in claim 1, wherein said spring member is a torsional spring, having two spring arms respectively connected between the two distal ends of said compressible spring body and said two end portions; said spring member can be a coiled spring and a spring plate.
